(19) United States
(12) Patent Application Publication
(10) Pub. No.: US 2007/0260160 A1
(43) Pub. Date: Nov. 8, 2007

(54) Aspirator Generating Crinis of Bald-Head

(76) Inventor: Jon On-Kuk, Seoul (KR)

Correspondence Address: IPLA P.A., 3580 WILSHIRE BLVD., 17TH FLOOR, LOS ANGELES, CA, 90010, US

(21) Appl. No.: 10/597,265

(22) PCT Filed: Jan. 26, 2005
(86) PCT No.: PCT/KR05/00210

§ 371 Date: Jul. 18, 2006

(30) Foreign Application Priority Data
Jan. 30, 2004 (KR) 20-2004-0002295

(51) Int. Cl. A61H 7/00

(52) U.S. Cl. 601/12

(57) ABSTRACT

The aspirator for generating crinis for a baldhead is disclosed. The aspirator is capable of enhancing a blood circulation in such a manner that an aspirator is tightly contacted with a skin having no hairs (from a forehead, rear sides of ears to a back neck) for thereby generating a certain vacuum pressure at a head skin.

### 1. TECHNICAL FIELD

The present invention relates to an aspirator for generating crinis for a baldhead, and in particular to an aspirator for generating crinis for a baldhead capable of maintaining a certain vacuum pressure at a portion of a head skin having no hairs and enhancing a blood circulation.

### 2. BACKGROUND ART

The term “Boohanggi (Korean)” represents an aspirator designed to remove waste substances from a human skin in such a manner that the aspirator is tightly attached to a human skin for thereby generating a certain vacuum state between the aspirator and the human skin. The aspirator is a kind of medical device that has been generally used in a Korean traditional medical hospital. The aspirator is attached at a head skin having no hairs and forms a certain vacuum state between the aspirator and the head skin for thereby sucking waste substances from the head skin and enhancing a blood circulation, resulting in a generation of crinis.

In Korea and China, a method for curing a certain disease using aspirators has been traditionally used. The effects of the aspirator method have been verified in the history. In Korea, common people can use the aspirator method. The aspirator method is generally classified into a dry type method, a wet type method, a foam type method and a reciprocation type method. Recently, the application range of the aspirator has been widened based on the use of a far infrared ray, magnetic force, low frequency, small current, etc.

In addition, the structure of the aspirator has been changed in various types. Namely, in the past, wheat flour was used for sealing an air gap like at a bent portion like an ankle. However, instead of the wheat flour, a rubber sealing ring is developed for the same purpose. The aspirator has been used for any portion of a human body such as a back, abdomen, hands, feet, arm, leg, etc. However, in the conventional art, the aspirator cannot be used for a head because there are hairs. Namely, a desired vacuum state is not obtained at the head portions because air is leaked between hairs.

It is known that when modern people have stresses, a blood circulation problem occurs, so that a normal nutrition supply is not performed at head, whereby a baldhead problem occurs because an acupuncture region and energy are blocked. In order to overcome the above problems, there has been provided a method for managing a health head skin and achieving a smooth blood circulation.

According to the Korean utility model application No. 2003-38894 (filing date: Dec. 12, 2003) filed by the same application as the present invention, in the head skin aspirator, a certain vacuum pressure is generated at a head portion using a towel type outer skin. However, when the above aspirator is attached at a head portion, it is impossible to fully prevent the air gaps between hairs in the conventional aspirator.

### DISCLOSURE OF INVENTION

Accordingly, it is an object of the present invention to overcome the above-described problems encountered in the conventional art.

It is another object of the present invention to provide an aspirator for generating crinis for a baldhead capable of enhancing a blood circulation in such a manner that an aspirator is tightly contacted with a skin having no hairs (from a forehead, rear sides of ears to a back neck) for thereby generating a certain vacuum pressure at a head skin.

To achieve the above objects, there is provided an aspirator for generating crinis for a baldhead, comprising a smooth helmet that has a certain size enough for covering a portion having no hairs in a human head; a tube that is attached at an inner edge portion of the helmet for being inflated by air; a sealing packing of which a surface contacting with a human skin is made of a smooth material such as silicon wherein said sealing packing is attached to the tube; a jaw strip and a fixing ring for fixing the helmet to the head; an air injection pump that is attached to a front side of the helmet and is connected with a hose for filling air into the tube; an air hose of which one end is connected with an air switch and a vacuum pump, and the other end is connected with a connection unit for thereby making the interior of the helmet a vacuum state; and a filter that is attached at an inner upper side of the helmet for preventing the hairs from being sucked out during a vacuum sucking operation based on an operation of the vacuum pump and has a plurality of small holes connected with the connection unit, whereby the air hose and the helmet are integrally engaged using the connection unit, so that a certain vacuum pressure is obtained in the interior of the aspirator during a vacuum absorption operation.

The helmet is made of one material selected among transparent resin, plastic or engineering plastic so that a certain change of the head skin is visually checked during an aspiration therapy.

The filter is made of one material selected among transparent resin, plastic or engineering plastic so that a certain change of the head skin is visually checked during an aspiration therapy.

A plurality of massage protrusions are installed at an inner side of the filter directly contacting with the head skin.

To achieve the above object, there is provided an aspirator for generating crinis for a baldhead characterized in that said aspirator of claim 1 is used as a device for generating crinis by enhancing a blood circulation at a portion having no hairs.

### BRIEF DESCRIPTION OF DRAWINGS

The present invention will become better understood with reference to the accompanying drawings which are given only by way of illustration and thus are not limitative of the present invention, wherein;

FIG. 1 is a perspective view illustrating a helmet-shaped aspirator according to the present invention;

FIG. 2 is an enlarged cross sectional view illustrating a connection unit of FIG. 1;

FIG. 3 is an enlarged cross sectional view illustrating a filter of FIG. 1;

FIG. 4 is a cross sectional view taken along line A-A′: of FIG. 1;

FIG. 5 is a cross sectional view taken along line A-A′ of FIG. 1 when air is filled in a tube; and

FIG. 6 is a view illustrating a state of use of an aspirator for generating crinis of a baldhead.

### BEST MODE FOR CARRYING OUT THE INVENTION

The preferred embodiments of the present invention will be described with reference to the accompanying drawings.

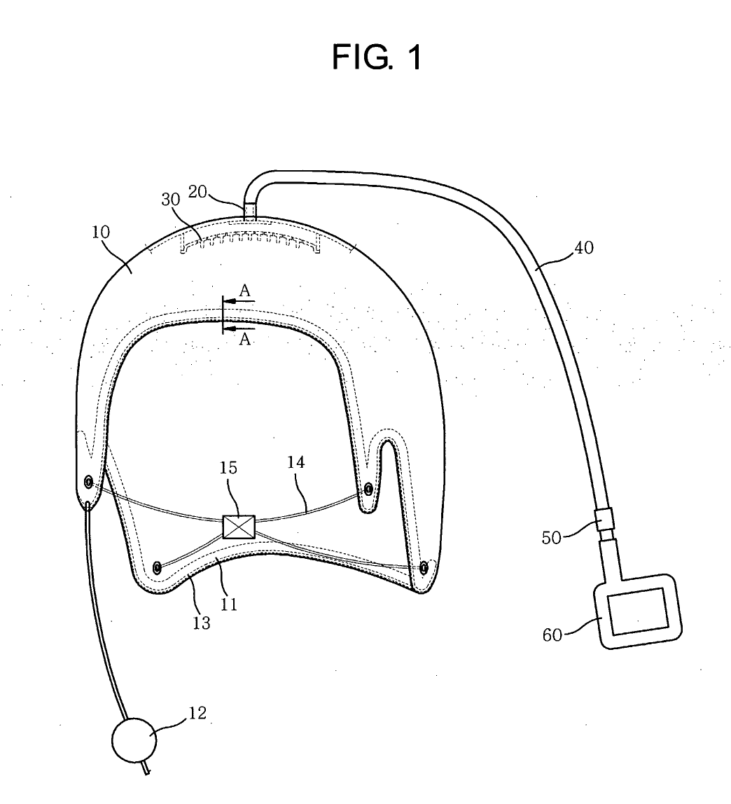

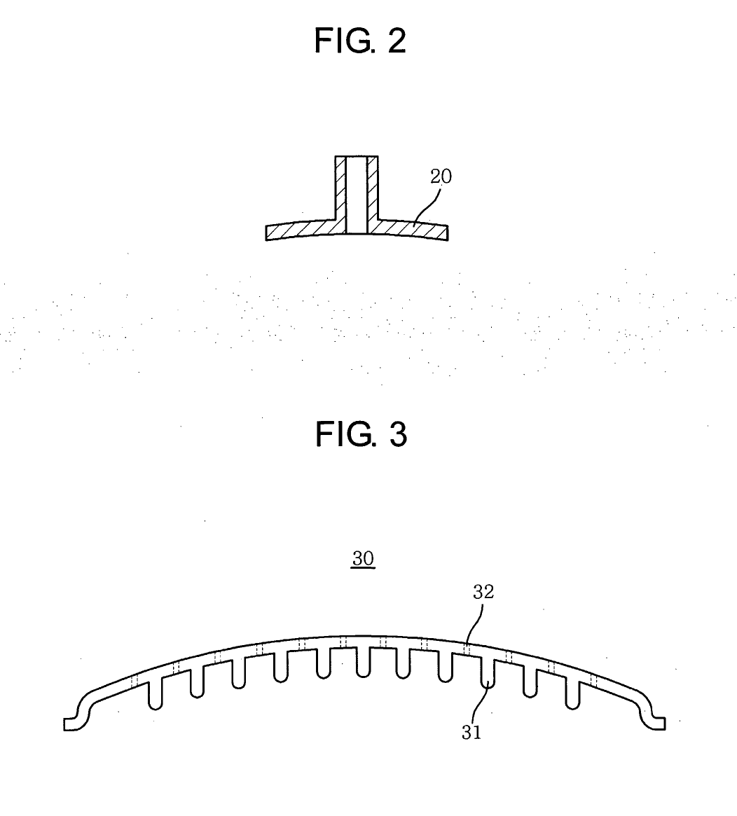

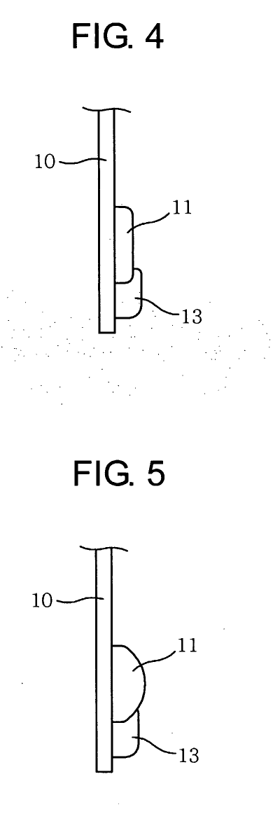

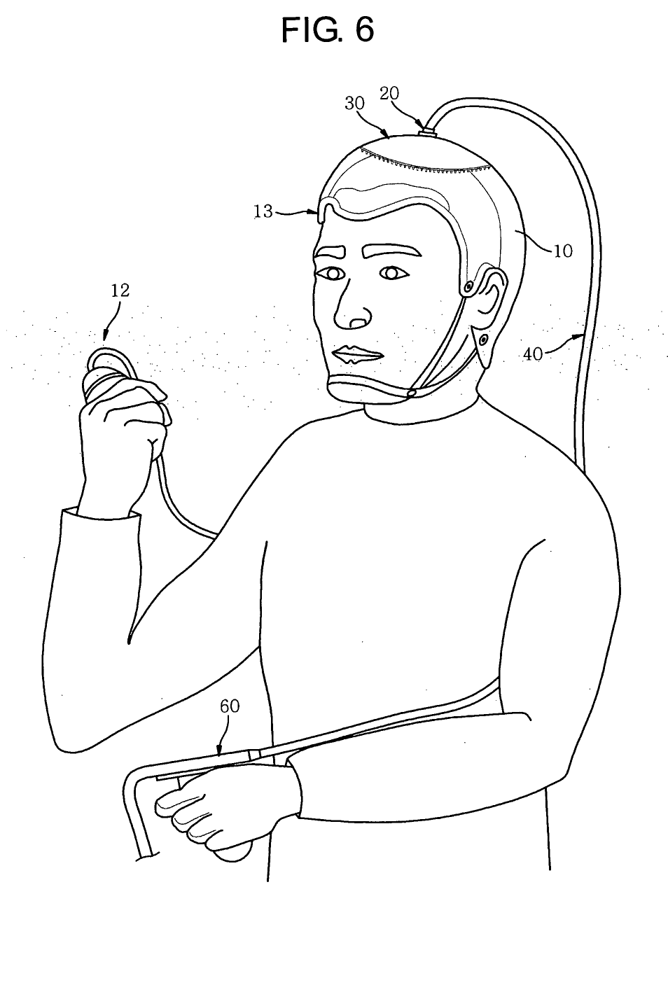

FIG. 1 is a perspective view illustrating a helmet-shaped aspirator according to the present invention, FIG. 2 is an enlarged cross sectional view illustrating a connection unit of FIG. 1, FIG. 3 is an enlarged cross sectional view illustrating a filter of FIG. 1, FIG. 4 is a cross sectional view taken along line A-A′ of FIG. 1, FIG. 5 is a cross sectional view taken along line A-A′ of FIG. 1 when air is filled in a tube, and FIG. 6 is a view illustrating a state of use of an aspirator for generating crinis of a baldhead.

As shown in FIG. 1, the aspirator for generating crinis for a baldhead according to the present invention comprises a smooth helmet 10 that has a certain size enough for covering a portion having no hairs in a human head; a tube 11 that is attached at an inner edge portion of the helmet for being inflated by air; a sealing packing 13 of which a surface contacting with a human skin is made of a smooth material such as silicon wherein said sealing packing 13 is attached to the tube 11; a jaw strip 14 and a fixing ring 15 for fixing the helmet 10 to the head; an air injection pump 12 that is attached to a front side of the helmet 10 and is connected with a hose for filling air into the tube 11; an air hose 40 of which one end is connected with an air switch 50 and a vacuum pump 60, and the other end is connected with a connection unit 20 for thereby making the interior of the helmet 10 a vacuum state; and a filter 30 that is attached at an inner upper side of the helmet 10 for preventing the hairs from being sucked out during a vacuum sucking operation based on an operation of the vacuum pump 60 and has a plurality of small holes connected with the connection unit 20, whereby the air hose 40 and the helmet 10 are integrally engaged using the connection unit 20, so that a certain vacuum pressure is obtained in the interior of the aspirator during a vacuum absorption operation.

The operation of the present invention will be described. As shown in FIGS. 1 and 6, a user wears the helmet 10 on head and adjusts the length of the jaw string 14. The tube 11 is inflated using an air pump. The tube 11 is expanded and gets well fitted with the head. The air supply is first stopped. As shown in FIG. 5, the air is properly filled into the tube 11, and the sealing packing 13 formed at the tube 11 is closely contacted with the skin having no hairs. In the above state, the vacuum pump 60 is operated, and the small gaps between the skin and hairs are sealed by a soft sealing packing 13 attached to an outer side of the expanded tube 11, and the air supply is second stopped. Therefore, it is possible to maintain a desired vacuum state in the interior of the helmet type aspirator.

As shown in FIG. 3, the filter 30 having small holes 32 is designed to prevent the hairs from being sucked during the vacuum sucking operation. In addition, the filter has a function of maintaining a vacuum pressure formation space between the forehead to the crown of the head. A plurality of massage protrusions 31 are formed at the inner side of the filter 30, namely, at the surface contacting with the head skin for thereby achieving a desired massage effect at the head skin during the vacuum sucking operation.

Various functional materials such as a magnet or a material capable of generating a far infrared ray may be attached at a contacting surface with the head skin of the massage protrusion 31 for thereby significantly enhancing a blood circulation effect of the head skin. A beret type cap may be used for covering the head skin instead of the helmet 10. In the case of a user who has alopecia and wants to cure the alopecia problem, the shape of the aspirator may be changed based on the shape of the head portion having no hairs.

As shown in FIG. 2, the connection unit 20 is designed to fix and engage the air hose 20 to the helmet and is preferably installed at the upper center portion of the helmet 10. The connection unit 20 may be connected at a back surface or a lateral surface of the helmet 10 by changing the design.

As shown in FIG. 6, the air hose 40 is connected with the vacuum pump 60, and the air switch 50 capable of opening and closing the air is formed at an end of the air hose 40, so that the user can directly check and use it conveniently.

As shown in FIG. 1, the air pump 12 capable of filling the air into the tube 11 is well known as a device that has been generally used for measuring the blood pressure. The vacuum pump 60 is a common aspirator and is fabricated in a manual type or a motored type.

### INDUSTRIAL APPLICABILITY

As described above, in the present invention, the blood circulation of the head skin is significantly enhanced, and it is possible to effectively generate crinis of people who suffer from a baldhead or alopecia.

In particular, the outer skin of the aspirator is formed in a helmet shape in the present invention for thereby overcoming the problems encountered in the conventional art in which hairs are too pressurized because the aspirator is vacuum-contacted with the head skin and there are too much sweat in the summer season.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An aspirator for generating crinis for a baldhead, comprising:
a smooth helmet 10 that has a certain size enough for covering a portion having no hairs in a human head;
a tube 11 that is attached at an inner edge portion of the helmet for being inflated by air;
a sealing packing 13 of which a surface contacting with a human skin is made of a smooth material such as silicon wherein said sealing packing 13 is attached to the tube 11;
a jaw strip 14 and a fixing ring 15 for fixing the helmet 10 to the head;
an air injection pump 12 that is attached to a front side of the helmet 10 and is connected with a hose for filling air into the tube 11;
an air hose 40 of which one end is connected with an air switch 50 and a vacuum pump 60, and the other end is connected with a connection means 20 for thereby making the interior of the helmet 10 a vacuum state; and
a filter 30 that is attached at an inner upper side of the helmet 10 for preventing the hairs from being sucked out during a vacuum sucking operation based on an operation of the vacuum pump 60 and has a plurality of small holes connected with the connection means 20, whereby the air hose 40 and the helmet 10 are integrally engaged using the connection means 20, so that a certain vacuum pressure is obtained in the interior of the aspirator during a vacuum absorption operation.

2. The aspirator of claim 1, wherein said helmet 10 is made of one material selected among transparent resin, plastic or engineering plastic so that a certain change of the head skin is visually checked during an aspiration therapy.

3. The aspirator of claim 1, wherein said filter 30 is made of one material selected among transparent resin, plastic or engineering plastic so that a certain change of the head skin is visually checked during an aspiration therapy.

4. The aspirator of claim 3, wherein a plurality of massage protrusions 31 are installed at an inner side of the filter 30 directly contacting with the head skin.

5. An aspirator for generating crinis for a baldhead characterized in that said aspirator of claim 1 is used as a device for generating crinis by enhancing a blood circulation at a portion having no hairs.
